(19) United States
(12) Patent Application Publication
(10) Pub. No.: US 2011/0094592 A1
(43) Pub. Date: Apr. 28, 2011

(54) Fluid Check Valve with a Floating Pivot

(75) Inventors: Howard Shi-How Cheng, Chandler, AZ (US); Kevin Kuo-Tsai Cheng, Chandler, AZ (US)

(73) Assignee: Howard Cheng, Chandler, AZ (US)

(21) Appl. No.: 12/910,770

(22) Filed: Oct. 22, 2010

Related U.S. Application Data
(60) Provisional application No. 61/253,940, filed on Oct. 22, 2009.

(51) Int. Cl. F15D 1/00; F16K 15/00

(52) U.S. Cl. 137/1; 137/511

(57) ABSTRACT

A fluid check valve consisting of a pair of leaflets contained within an annular body member (10). These leaflets (16 and 17) open and close hemodynamically as a reaction to the natural pumping action of the heart. They open from the center outward based upon their S shape profile (45). Blood flows through the interior surface (12) of the annular body member and leaflets. These leaflets open and close relying upon, protruding rails from the annular body member (20 and 21) and their integrated stop means (31-38). The protruding rails guide the leaflets in a floating pivot action that virtually eliminates area of stasis and prevent thrombosis.

### CROSS-REFERENCE TO RELATED APPLICATIONS

This application claims the benefit of provisional patent application Ser. No. 61/253,940, filed 2009 Oct. 22 by the present inventor.

### FEDERALLY SPONSORED RESEARCH

None

### SEQUENCE LISTING

None

### BACKGROUND OF THE INVENTION

1. Field of Invention

This invention relates to prosthetic heart valves, specifically to certain bi-leaflet prosthetic heart valve models.

2. Prior Art

A variety of bi-leaflet prosthetic heart valves exist in the market today. These heart valves generally consist of semi-circular or semi-elliptical plates, which act as occluders or leaflets and are contained within an annular body member. This annular body member acts as a passageway for blood to flow through while the leaflets open and close hemodynamically as a reaction to the normal pumping action of the heart.

The natural flow of fluid through a pipe results in a maximum velocity at the pipe center with minimal velocity at the outer edge of the pipe. This being known, all present bi-leaflet prosthetic heart valves open from the outer edge of the annular body member. This means that blood must be force to flow to the outer edges of the artery in order to open the leaflets. This causes a delayed opening and closing cycle of the leaflets and will create the risk of regurgitation.

Another issue with most bi-leaflet mechanical heart valves is the presence of cavities within the annular body member. Some examples are claimed in U.S. Pat. No. 4,254,508, Bokros and U.S. Pat. No. 5,641,324, Bokros. These cavities act as a pivot point for the leaflets and control the maximum range of movement. These cavities are hidden from the natural washing turbulence present within the blood flow and will result in areas of stasis. These areas will eventually develop thrombus and increase the risk of thrombosis. U.S. Pat. No. 5,354,330, Hanson Kramp Villafana, U.S. Pat. No. 4,692,165, Bokros and U.S. Pat. No. 4,822,353 Borkos, addresses this issue by creating a convex pivot arrangement which eliminates cavities from the walls of the annular body member.

However, this convex pivot arrangement still does not address the issue of a fixed pivot. Fixed pivotal areas create areas of stasis specifically at the center of the pivot where blood cannot be thoroughly washed. After long term use, this area of stasis may result in thrombus and increase the risk of thrombosis.

3. Objects and Advantages

(a) to provide a valve with central flow characteristics to aid in improved responsiveness and thus limiting regurgitation by splitting the leaflets in a S shape, thus allowing the leaflets to open from the center and pivoting outward;

(b) to provide a valve without any cavities in which a state of stasis may occur by only allowing the addition of smooth convex surfaces to the annular body member;

(c) to provide a valve with a floating pivot thus maintaining leaflet movement at all times in order to encourage washing of blood and prevent areas stasis;

(d) to provide a valve with a long and short term durability with the application of various types of material including but not limited to biocompatible polyurethane, ceramic, carbon, metals and nano-engineered polymers.

### SUMMARY

In accordance with the present invention, a fluid check valve with central flow characteristics and a floating pivot design.

### DRAWINGS

### Figures

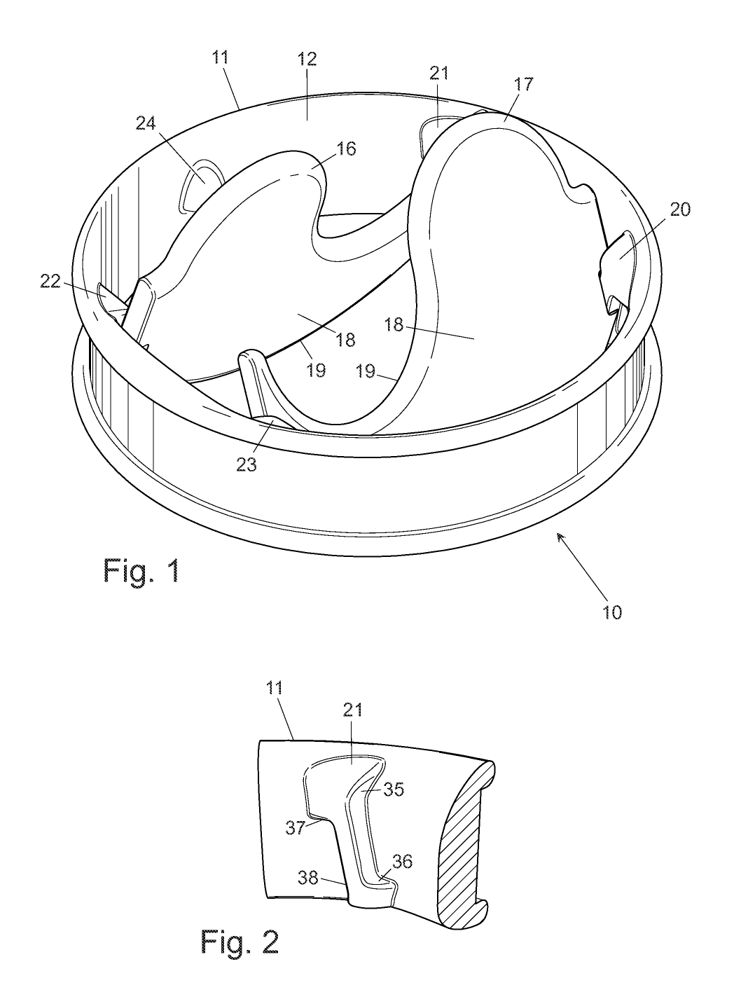

FIG. 1 is a perspective view of fluid check valve of the present invention, with the valve being shown from the outflow end, and shown with the leaflets in the open position;

FIG. 2 is a fragmental perspective view of the guide rail and stop means protruding from the annular body member;

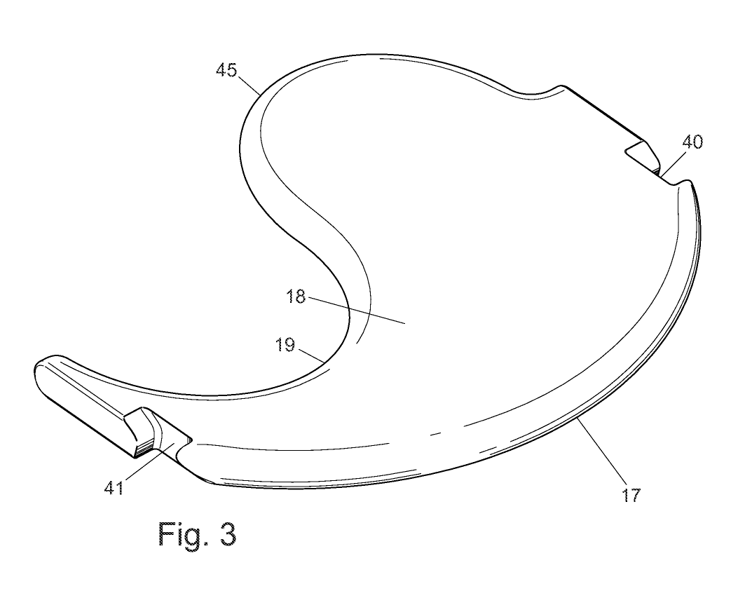

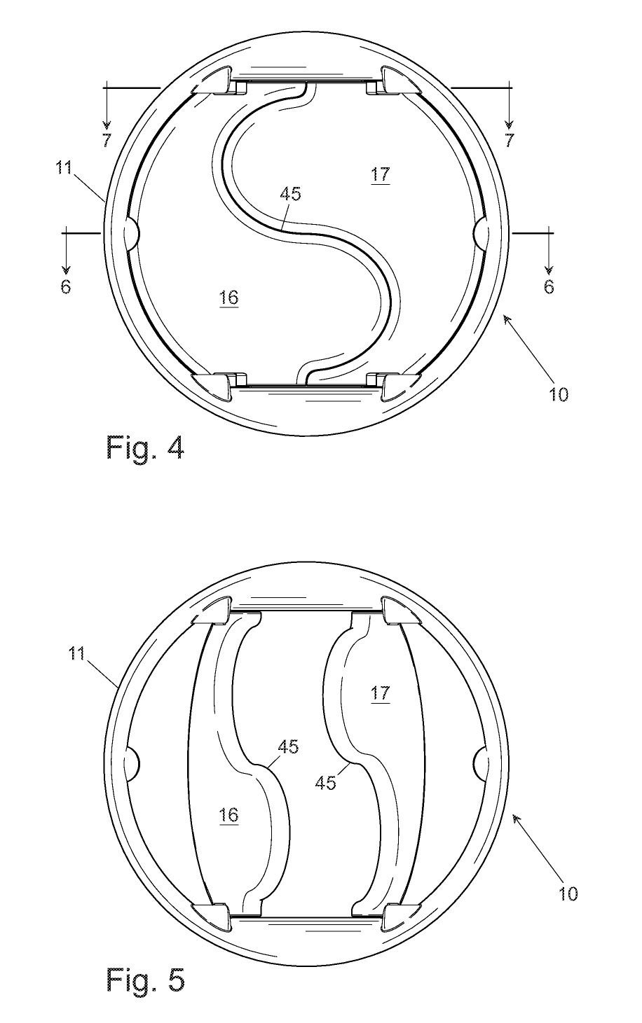

FIG. 3 is a perspective view of a leaflet separated from the annular body member;

FIG. 4 is a plan view of the prosthetic heart valve, with the valve shown from the outflow end, and shown with the leaflets in the closed position;

FIG. 5 is a plan view of the prosthetic heart valve, with the valve shown from the outflow end, and shown with the leaflets in the open position;

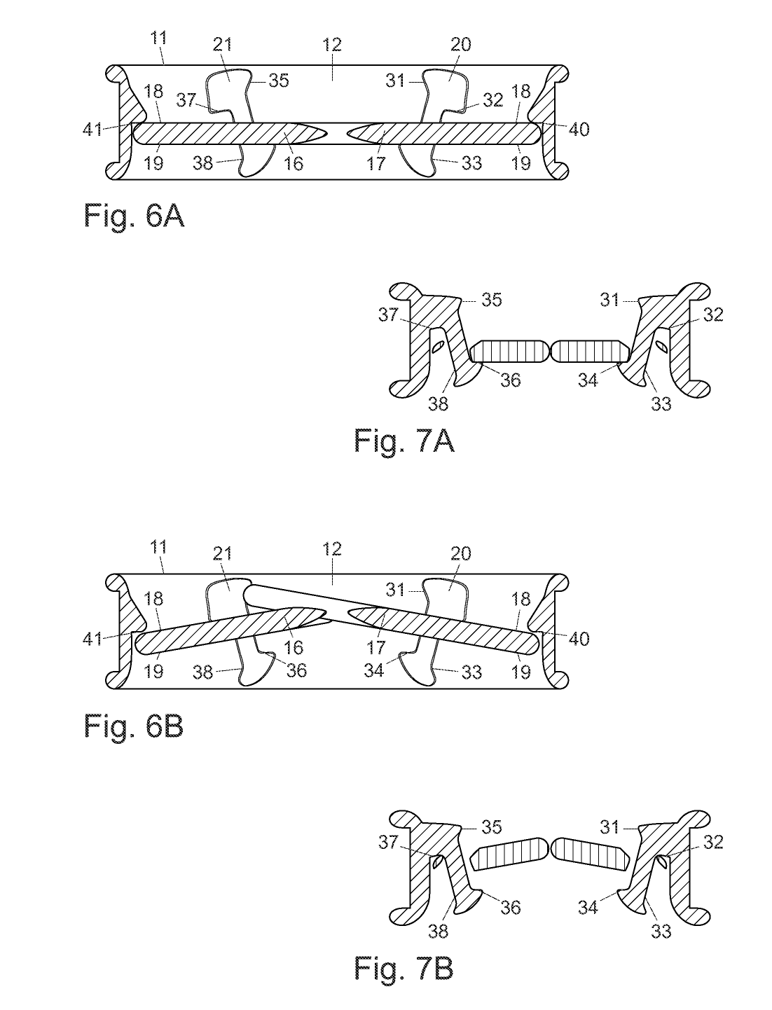

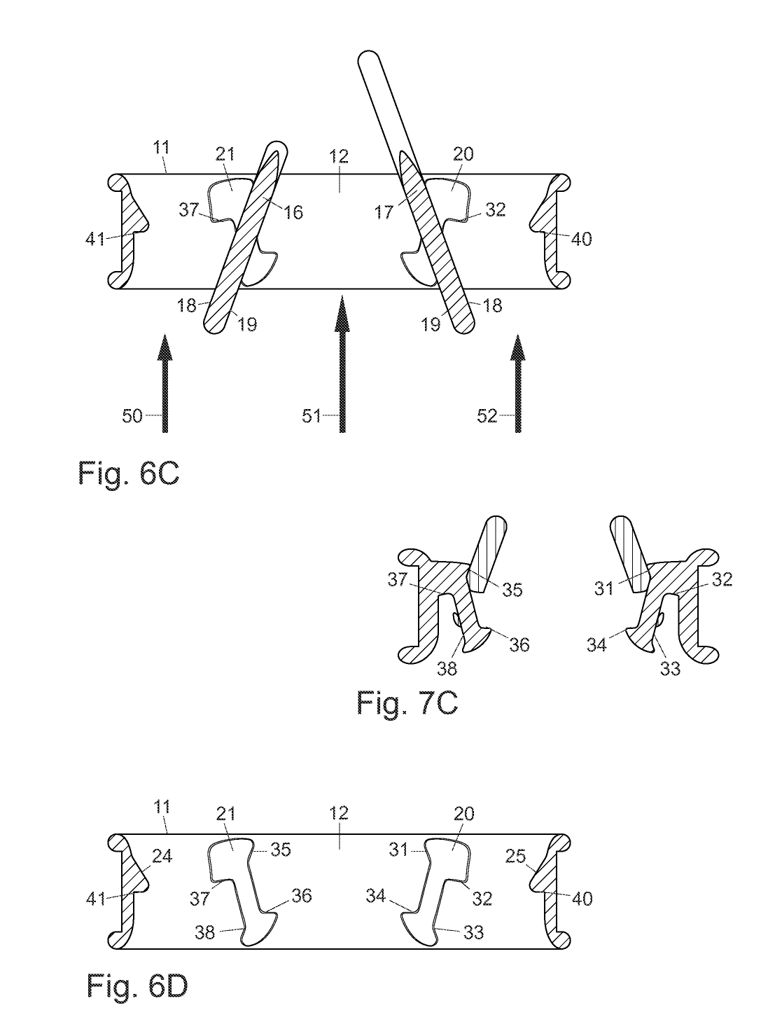

FIGS. 6A-6D is a vertical sectional view taken along the line and in the direction of the arrows 6-6 of FIG. 4; and

FIGS. 7A-7C is a vertical sectional view taken along the line and in the direction of the arrows 7-7 of FIG. 6.

### DETAILED DESCRIPTION

In accordance with the preferred embodiment of the present invention, and with particular attention being directed to FIG. 1 of the drawings, the fluid check valve comprises of an annular body member 11 having an interior surface 12 defining a central passageway for blood flow. With attention being directed to FIG. 6C, the directional arrows 50, 51, 52 illustrate the flow pattern for blood passing through the fluid check valve. The leaflets 16 and 17 open from the center of the valve outwardly. The flow occurs between the individual leaflets 16 and 17 and the annular body member 11. The leaflets 16 and 17 are provided, with the leaflets having upstream directed major surfaces 19-19, and downstream directed major surfaces 18-18. The leaflets respond hemodynamically to the natural pumping action of the heart, as to open and close so as to permit blood flow through the passageway upon occurrence of an increase in pressure on the inflow side so as to cause a positive pressure differential relative to the outflow side of the device. Closure occurs as the relative pressures become positive with respect to the outflow side.

With attention now directed to FIGS. 1 and 2 of the drawings, each leaflet is provided with an aligned pair of cavities, as at 40 and 41. The cavities 40 and 41 are designed to receive protruding rails from the annular body member, as at 20 and 21. The utilization of the protruding rails provides a floating pivot and an integrated stop means for the leaflets. The leaflets border each other in an “S” shape 45, enabling opening of the leaflets through a central force. The dimensional tolerances are typically such that a normal gap of 0.015-0.025 mm exists between the leaflets and the annular body including the protruding rails, with this dimension being sufficient to accommodate free movement and flow while able to resist regurgitation when closed.

With attention directed to FIGS. 6-7 of the drawings, a plurality of stop means are provided which are integrated with the protruding rail from the annular body. These rails are inwardly facing surfaces which are formed generally along chordal planes of the interior surface of the annular body member. These protruding rails are tapered and flared outwardly while still providing a flat surface sufficient for the travel of the leaflet. The projected rails, smoothly merges or blends into the annular body member. This design creates a smooth surface to improve blood flow and reduce areas of stasis. Integrated stop means shown at 31-38 extend inwardly off the interior wall 12. The stop means are provided with abutment surfaces to control the extent of pivotal motion of each leaflet 16 and 17 so as to achieve opening and closing of the valve.

When the valve leaflets are in the closed position, the leaflets 16 and 17 rest upon abutment surfaces 35, 36, 40 and 41. When the valve leaflets are in the open position, the leaflets rest upon abutment surfaces 31, 33, 35 and 38.

Turning now to the operation of the fluid check valve 10, upon the occurrence of the natural pumping action of the heart, when the inflow pressure exceeds the outflow pressure, thus causing blood to flow along the direction of the arrows with maximum velocity in the center of the passageway. With attention directed towards FIGS. 6A and 7A, this velocity pushes the leaflets from the center and the initial stop means, as at 34, 36, 40 and 41. In FIGS. 6B and 7B, the leaflets 16 and 17 pivot on stop means 40 and 41 until they contact the second set of stop means, as at 32 and 37. The second set of stop means now acts as a pivotal point for the leaflets. In FIGS. 6C and 7C, the leaflets then pivot upon the second set of stop means until the maximum angle of the leaflet is limited by the third set of stop means, as at 31, 33, 35 and 38. During the pressure reversal portion of the normal cycle, the leaflets will return to their closed position in FIGS. 6A and 7A.

To reach the open position, the leaflets 16 and 17 must first rotate 5-10 degrees from the first center of rotation depending on the initial stop means. Then the leaflets will proceed to rotate the additional 60-75 degrees based upon the second and third set of stop means. In the open position, the maximum rotation of the leaflets is modestly less than parallel to the flow direction in order to aid in a quick return to the closed position. The normal human heart rate is approximately 72 beats per minute at rest, which increases as a result of exercise, resulting in a substantial numbers of cycles for the prosthetic heart valve. For this, the valve may be made of any suitable material that resists wear and maintains biocompatibility.

Other modifications may be made to the device described hereinabove without actually departing form the spirit and scope of the present invention.

I claim:

1. A device comprising a generally annular body member containing a plurality of protruding rails thereby guiding a plurality of occluder means.

2. A fluid check valve in accordance with claim 1 wherein said annular body member has a central passageway for fluid flow.

3. A fluid check valve in accordance with claim 1 wherein said protruding rails contain integrated stop means, which limit the predetermined travel of said occluder means.

4. A fluid check valve in accordance with claim 1 wherein said occluder means comprising of a pair of leaflets which border each other with an approximate “S” shaped profile.

5. A fluid check valve comprising a plurality of occluder means surrounded by a generally annular body member with a plurality of protruding rails.

6. A device in accordance with claim 4 wherein said occluder means comprising a pair of leaflets bordering each other with an “S” shaped curve.

7. A device in accordance with claim 4 wherein said annular body member is a means for a fluid flow passageway.

8. A device in accordance with claim 4 wherein said protruding rails comprising integrated stop means, thereby limiting said occluder means to pivoting and sliding movements within a predetermined path.

9. A method of starting and stopping the flow of fluid, comprising:
(a) Providing a device comprising a generally annular body member with a plurality or protruding rails thereby guiding a plurality of occluder means in a predetermined path,
(b) Providing a flow of fluid to open and close said device,
(c) Opening said device with a positive flow of fluid thereby pivoting and sliding said occluder means in a predetermined path defined by said protruding rails,
(d) Closing said device with a negative flow of fluid thereby pivoting and sliding said occluder means in a predetermined path defined by said protruding rails.
